(19) United States
(12) Patent Application Publication
(10) Pub. No.: US 2007/0262969 A1
(43) Pub. Date: Nov. 15, 2007

(54) TOUCH SCREEN DEVICE AND METHOD OF ELIMINATING NOISE THEREOF, AND LIQUID CRYSTAL DISPLAY DEVICE HAVING THE SAME

(75) Inventor: Sang Jin PAK, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/747,017

(22) Filed: May 10, 2007

(30) Foreign Application Priority Data
May 11, 2006 (KR) 10-2006-0042215

(51) Int. Cl. G06F 3/041

(52) U.S. Cl. 345/173

(57) ABSTRACT

A touch screen device, a method of eliminating a noise thereof and a liquid crystal display having the same include converting an analog signal inputted from a plurality of sensors of a touch screen into digital raw data, aligning the digital raw data on a frame basis, eliminating an offset noise from the digital raw data aligned on a frame basis, and identifying a sensor signal within the digital raw data by comparing a variation of the digital raw data in a previous frame to a variation of the digital raw data in a current frame.

This application claims priority to Korean Patent Application No. 2006-42215, filed on May 11, 2006, and all the benefits accruing therefrom under 35 U.S.C. § 119, the contents of which in its entirety are herein incorporated by reference.

### BACKGROUND OF THE INVENTION

(a) Field of the Invention

The present invention relates to a touch screen device, a method of eliminating noise thereof and a liquid crystal display device having the touch screen device. More specifically, the present invention relates to a touch screen device, a method of eliminating noise thereof and liquid crystal display device having the same in which a noise component of a sensor signal is reduced to increase a signal-to-noise ratio.

(b) Description of the Related Art

Generally, a touch screen device is attached to a display device such as a liquid crystal display (“LCD”) or an organic light emitting diode (“OLED”) display to enable a user to input information by pressing a touch screen while viewing the display.

A touch screen device according to the prior art includes a touch screen, a plurality of sensors formed on the touch screen and a data processing unit which converts and processes a signal from the plurality of sensors. Due to various factors, the sensor signal supplied from the corresponding sensor is distorted, resulting in errors in a display device attached to the touch screen device.

FIG. 1 is a block diagram of an LCD device of the prior art on which a touch screen device of the prior art is formed. FIG. 2 is a quantitative diagram of a sensor signal and noise in an output signal of the sensor of FIG. 1.

Referring to FIG. 1, the touch screen device includes a touch screen 20 formed on an upper surface of an LCD panel 10, a sensor 60 included in the touch screen 20, a power unit 30 which supplies power to the sensor 60, an amplifying & analog-to-digital converting unit 40 which amplifies an analog sensor signal inputted from the sensor 60 and digitally converts the amplified analog sensor signal into a digital sensor signal, and a digital signal processing unit 50 which processes the digital sensor signal supplied by the amplifying & analog-to-digital converting unit 40.

The power unit 30 supplies a power signal to a driving unit (not shown) which drives the LCD panel 10, the sensor 60 and the amplifying & analog-to-digital converting unit 40. The sensor 60 is provided on the touch screen 20 and senses an outside input (not shown) and supplies the analog sensor signal to the amplifying & analog-to-digital converting unit 40. Since the analog sensor signal supplied to the amplifying & analog-to-digital converting unit 40 is supplied as an analog signal, an amplitude of the signal is amplified and digitally converted by the amplifying & analog-to-digital converting unit 40 for signal processing by the digital signal processing unit 50.

Various elements affect the analog and the digital sensor signals (hereinafter collectively referred to as a “sensor signal” in reference to the prior art) of the sensor 60 in the LCD panel 10. For example, but not being limited thereto, the sensor signal is affected by capacitances C1, C2, C3, and C4 and resistances (not shown) due to gate and data driving signals supplied to gate and data lines (not shown), respectively, a common voltage signal applied to a common electrode (not shown), and a coupling signal between the signal lines and pixel electrodes (not shown). In summary, any signal except the sensor signal is noise which generates errors in the LCD device of the prior art.

In addition, the touch screen 20 and the sensor 60 physically overlap each other, as shown in FIG. 1, which generates additional noise which further affects the sensor signal.

Referring to FIG. 2, a sensor signal outputted from the sensor 60 includes a signal, e.g., the sensor signal, and noise which overlaps the sensor signal. Furthermore, the noise can be classified as random noise and offset noise. The random noise includes noise generated by heat, noise generated from various signal lines and capacitances within the LCD panel 10, and noise generated from manufacturing deviations in the sensor 60 and the LCD panel 10, for example, but are not limited thereto. It is difficult to predict time frequency, amplitude, time duration and polarity of the random noise.

The offset noise is generated due to imperfections within the power unit and is difficult to predict frequency, amplitude, time duration and polarity thereof.

To measure a relative strength of a signal compared to a strength of noise, a signal-to-noise ratio (“SNR”), expressed in decibels (“dB”) is calculated. The SNR is calculated as expressed in Formula 1:

$$SNR = 20 {log}_{10} ( \frac{Vs}{Vn} ) \qquad ( 1 )$$

where Vs is a signal amplitude and Vn is a noise amplitude. If the signal amplitude is greater than the noise amplitude, a resulting SNR is a positive number. If the signal amplitude is less than the noise amplitude, a resulting SNR is a negative number. It is desired that SNR be a positive number in the touch screen device. Therefore, in the touch screen device the sensor signal amplitude should be greater than zero and, further, should have be at least equal to or greater than a critical amplitude, e.g., a sensor signal amplitude which is greater than the noise amplitude by an amount which depends upon the sensor device and an operating environment.

Referring back to Formula 1, if the sensor signal and the noise overlapping the sensor signal are amplified by an amplifier having a gain of about 40 dB, for example, but is not limited thereto, both the sensor signal and the noise are amplified. More specifically, if both Vs and Vn are simultaneously increased by an equal amount, the SNR decreases. However, it is desired to increase the SNR, but it is difficult to separate the signal and the noise from each other. Hence, the SNR of the amplified signal gets worse, resulting in a problem in which the noise is erroneously recognized as the sensor signal by the digital signal processing unit 50.

### BRIEF SUMMARY OF THE INVENTION

An exemplary embodiment of the present invention provides a touch screen device and method of eliminating noise thereof which improves a signal-to-noise ratio (“SNR”) by eliminating an offset noise overlapping a sensor signal from a sensor. The method includes generating digital raw data by converting an analog signal inputted from a plurality of sensors of a touch screen, aligning the digital raw data on a frame basis, eliminating an offset noise from the digital raw data aligned on a frame basis, and identifying a sensor signal within the digital raw data by comparing a variation of the digital raw data in a previous frame to a variation of the digital raw data in a current frame.

The raw data includes the sensor signal, the offset noise and a random noise.

Aligning the digital raw data on a frame basis includes sampling the digital raw data to extract desired data from the digital raw data aligned on a frame basis.

Eliminating the offset noise includes subtracting the offset noise corresponding to an average of the digital raw data received from the plurality of sensors over time.

The method may further include eliminating the random noise from the digital raw data by subtracting a random noise component of the previous frame from the digital raw data in the current frame.

Another exemplary embodiment of the present invention provides a touch screen device including a touch screen having a plurality of sensors, an analog-to-digital converting unit which generates digital raw data by converting an analog signal measured by the plurality of the sensors and a digital signal processing unit which aligns the digital raw data on a frame basis, eliminates an offset noise from the digital raw data aligned on a frame basis, and identifies a sensor signal within the digital raw data by comparing a variation of the digital raw data in a previous frame to a variation of the digital raw data in a current frame.

The digital signal processing unit may further eliminate a random noise from the digital raw data by subtracting a random noise component of the previous frame from the digital raw data in the current frame.

Another exemplary embodiment of the present invention provides a liquid crystal display (“LCD”) device including an LCD, a touch screen having a plurality of sensors, an analog-to-digital converting unit which generates digital raw data by converting an analog signal measured by the plurality of sensors into digital data and a digital signal processing unit which aligns the digital raw data on a frame basis, eliminates an offset noise from the digital raw data aligned on a frame basis, identifies a sensor signal within the digital raw by comparing a variation of the digital raw data in a previous frame to a variation of the digital raw data in a current frame, and outputs the identified sensor signal to the liquid crystal display.

The digital signal processing unit may further eliminate a random noise from the digital raw data by subtracting a random noise component of the previous frame from the digital raw data in the current frame.

### BRIEF DESCRIPTION OF THE DRAWINGS

The above and other aspects, features and advantages of the present invention will become more apparent by describing in further detail exemplary embodiments thereof with respect to the accompanying drawings, in which:

FIG. 1 is a block diagram of a liquid crystal display device of the prior art on which a touch screen device of the prior art is formed;

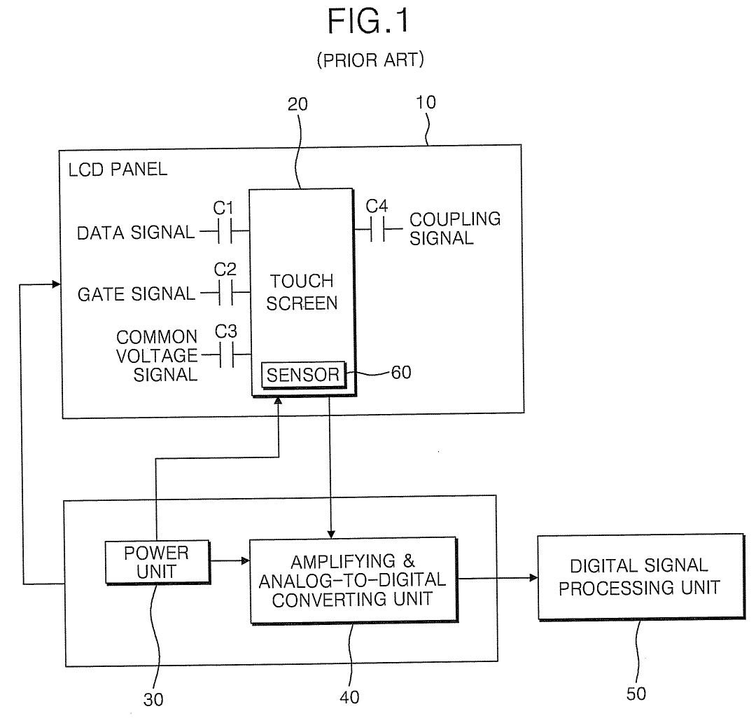

FIG. 2 is a quantitative diagram of a sensor signal and a noise in an output signal of the sensor of FIG. 1;

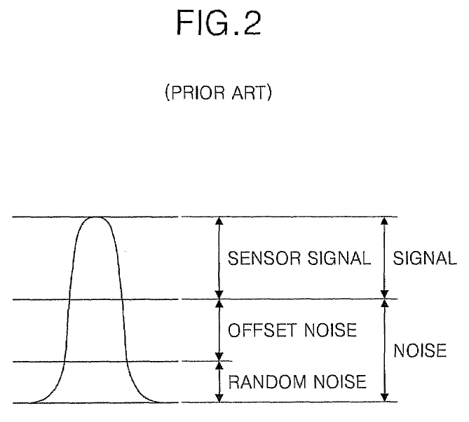

FIG. 3 is a flow chart illustrating a method of eliminating an offset noise of a touch screen according to an exemplary embodiment of the present invention;

FIG. 4A and FIG. 4B are graphs of a sensor output over a series of frames for signal-to-noise ratio comparisons of the sensor output with and without the method of FIG. 3 of eliminating the offset noise according to an exemplary embodiment of the present invention; and

FIG. 5 is a block diagram of a touch screen device according to an exemplary embodiment of the present invention.

### DETAILED DESCRIPTION OF THE INVENTION

The invention now will be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

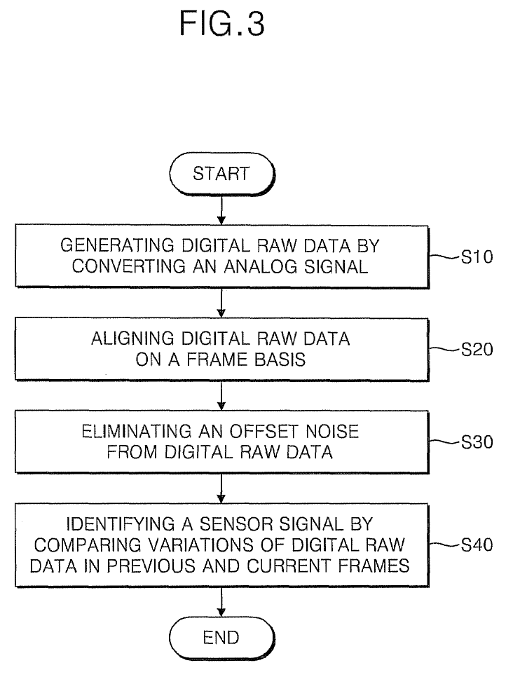

FIG. 3 is a flow chart illustrating a method of eliminating a noise of a touch screen according to an exemplary embodiment of the present invention.

Referring to FIG. 3, a method of eliminating a noise of a touch screen (not shown) according an exemplary embodiment of the present invention include generating a raw data signal by converting an analog signal supplied from a plurality of sensors (not shown) of the touch screen into a digital signal (step S10), aligning the raw data signal on a frame basis (step S20), eliminating an offset noise of the raw data signal aligned on a frame basis (step S30), and identifying a sensor signal within the raw data signal by comparing a variation of the raw data signal in a previous frame with a variation of the raw data signal in a current frame (step S40).

More specifically, the analog signal supplied from the plurality of sensors of the touch screen includes a sensor signal, an offset noise and a random noise.

The offset noise is generated from imperfections of a power unit (not shown) which supplies power to the sensor. Frequency, time duration, amplitude and polarity of the offset noise are difficult to estimate and/or predict. However, it is possible to measure an approximate amplitude of the offset noise for a particular frame.

The random noise includes a noise generated by heat, an interference noise generated from various signal lines and capacitances of a display panel (not shown) and noises generated from deviations in the fabrication process of the plurality of sensors and the display panel. It is difficult to estimate and/or predict frequency, time duration, amplitude and polarity of the random noise.

The analog signal supplied from the plurality of sensors of the touch screen, which includes the sensor signal, the offset noise and the random noise overlapping each other, is supplied to an analog-to-digital converting unit (not shown) from the plurality of sensors. The analog signal supplied from the plurality of sensors of the touch screen which is supplied to the analog-to-digital converting unit is amplified by an amplifier (not shown) to provide an amplified analog signal. The amplified analog signal is then converted into the raw data signal, which is a digital signal, by the analog-to-digital converting unit. More specifically, the amplified analog signal is inputted to the analog-to-digital converting unit, is sampled according to a sampling rate, is quantized, and is then digitized. The raw data signal, e.g., the digitally-converted amplified analog signal just described, is detected by a random sensor of the plurality of sensors at a random time, as determined by, for example, but is not limited thereto, a user touching and/or pressing the particular random sensor of the plurality of plurality of sensors. The raw data signal includes time information and position information corresponding to the particular random sensor of the plurality of random sensors which the user has touched. However, the raw data signal also contains information supplied from the untouched sensors as well, due to the offset noise and the random noise as described above. In other words, the raw data signal includes digitally converted components of the sensor signal from the particular random sensor which has been touched by the user, offset noise from all of the sensors of the plurality of sensors, and random noise from all of the sensors of the plurality of sensors.

The raw data signal contains raw data for a predetermined elapsed time according to a frame unit and is supplied to a data signal processing unit.

The digital signal processing unit aligns the raw data on a frame basis by simultaneously processing the raw data through a sensing frame. Further, the raw data is aligned on a frame basis such that only the raw data having significant information is sampled. More specifically, the sampling rate is adjusted according to a significance of a particular frame such that only significant raw data is extracted and is sampled at a maximum sampling rate, saving time in extracting or comparing the raw data.

According to an exemplary embodiment of the present invention, the offset noise component of the raw data aligned on a frame basis is extracted from the raw data and is eliminated, as described in further detail hereinafter. Since the offset noise of a given frame approximately corresponds to an average of the offset noise over an elapsed time, e.g., more than one frame, an averaged offset noise value is subtracted from the raw data for each frame. More specifically, since the user input to the touch screen is random and discontinuous, the digitally-converted component of the sensor signal corresponding to the particular random sensor which the user has touched is relatively small in comparison to the digitally-converted offset noise and random noise components from all sensors of the plurality of sensors over time. Thus, the digital signal processing unit integrates the offset noise and the random noise over time to calculate an average offset noise, and the calculated average offset noise is then subtracted from a single current whole frame of the raw data. This process is repeated for consecutive frames, with the result being that the offset noise is eliminated from the raw data by the digital signal processing unit. As a result, the raw data from which the offset noise is eliminated by the digital signal processing unit includes only the sensor signal and the random noise components and a signal-to-noise ratio (“SNR”), expressed in decibels (“dB”) and calculated according to Formula 1, is thereby increased.

$$SNR = 20 {log}_{10} ( \frac{Vs}{Vn} ) \qquad ( 1 )$$

where Vs is a signal amplitude and Vn is a noise amplitude.

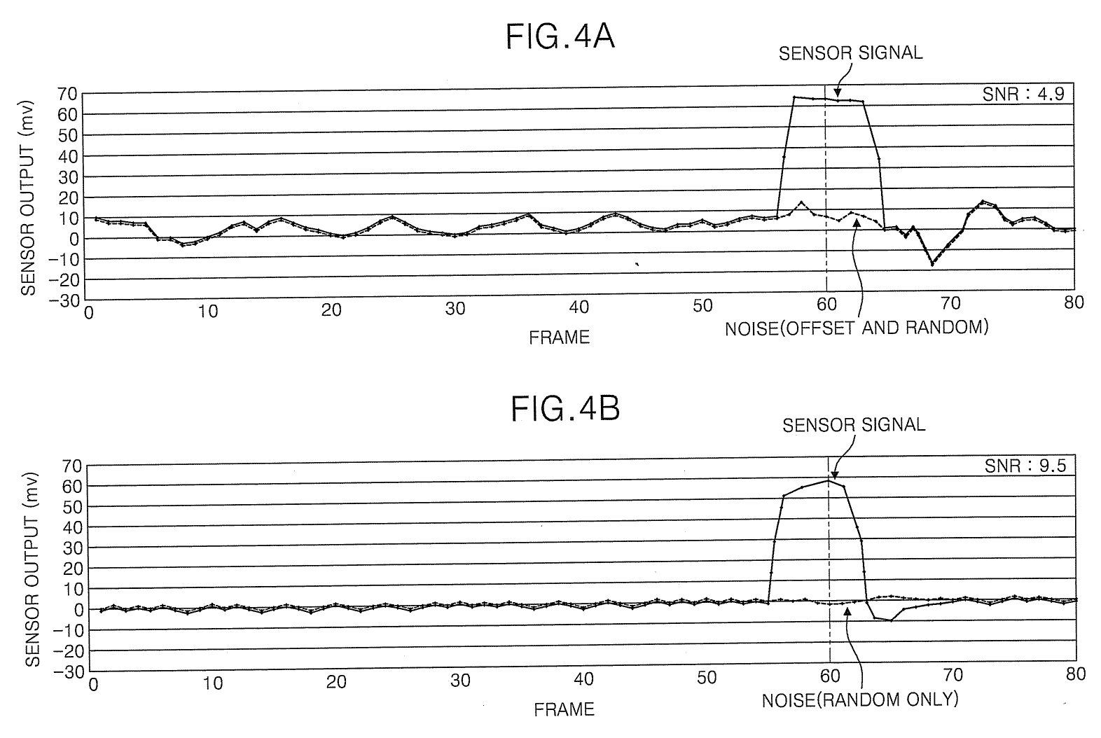

FIG. 4A and FIG. 4B are graphs of a sensor output over a series of frames for signal-to-noise ratio comparisons of the sensor output with and without the method of FIG. 3 of eliminating an offset noise according to an exemplary embodiment of the present invention. Specifically, FIG. 4A is a graph of the sensor output without the method of eliminating the offset noise and FIG. 4B is a graph of the sensor output with the method of eliminating the offset noise.

Referring to FIG. 4A and FIG. 4B, after an offset noise has been eliminated, an SNR measured in a same frame increases. Specifically, a sensor signal at frame 60 in FIG. 4A (before elimination of the offset noise) is about 64 mV and a level of a sensor signal measured at frame 60 in FIG. 4B (after elimination of the offset noise) is about 58 mV. Thus, the SNR according to Formula 1 before the elimination of the offset noise is about 4.9 dB, and the SNR after the elimination of the offset noise is about 9.5 dB, as shown in FIGS. 4A and 4B, respectively. Therefore, it is confirmed that SNR increases after elimination of the offset noise.

An amplitude of the random noise gradually increases as time elapses. However, it is desirable to keep the amplitude of the random noise low to allow the digital signal processing unit to identify and/or distinguish the sensor signal from the random noise. Hence, exemplary embodiments of the present invention further include a step which decreases the random noise, as described hereinafter in further detail.

The sensor signal is identified by the digital signal processing unit by comparing a variation of raw data in a previous frame to a variation of raw data in a current frame. Since the offset noise component has been eliminated from the raw data as described above, the remaining raw data includes only the sensor signal and the random noise component. An SNR in a current frame is not identical to that in a previous or a next frame when the raw data of the current frame is compared to the raw data of the previous or the next frame. For example, if an amplitude of the sensor signal in the previous frame is about 5 mV and an amplitude of the random noise component in the previous frame is about 0.1 mV, while a an amplitude of the sensor signal in the current frame is about 10 mV and an amplitude of the random noise component in the current frame is about 1 mV, SNRs calculated according to Formula 1 in the previous and current frames are about 34 dB and about 20 dB, respectively. Considering the calculated example SNRs, even when a level difference between the sensor signal and the random noise component is considerably large, the SNR is relatively small. In other words, sensor signal sensitivity is relatively low. Further, when random noise components of the previous and the current frames are compared to each other with respect to variations of a level of the random noise component, if the random noise component level in the current frame is greater than in the previous frame, the overall level of the raw data signal is reduced by subtracting the random noise component level of the previous frame. Even though subtracting the random noise component level of the previous frame reduces the overall level of the raw data, the SNR is nonetheless increased, enhancing the sensor signal sensitivity.

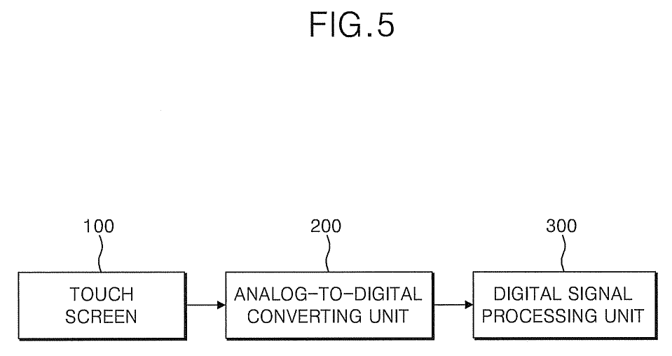

FIG. 5 is a block diagram of a touch screen device according to an exemplary embodiment of the present invention.

Referring to FIG. 5, a touch screen device according to an exemplary embodiment of the present invention includes a touch screen 100 having a plurality of sensors (not shown), an analog-to-digital converting unit 200 which generates raw data by converting an analog signal supplied from the plurality of sensors into digital data, and a digital signal processing unit 300 which aligns the raw data generated by the analog-to-digital converting unit 200 on a frame basis, eliminates an offset noise of the raw data aligned on a frame basis, and identifies a sensor signal by comparing a variation of the raw data in a previous frame to a variation of the raw data in a current frame.

More specifically, the touch screen 100 is attached to an upper surface of a display panel (not shown). The touch screen 100 includes transparent upper and lower electrodes (not shown) formed on the display panel and a spacer (not shown) between two substrates (not shown) to provide a space between the upper and lower electrodes. A protective film (not shown) is further provided on the upper electrode. When the two substrates come into contact with each other, e.g., by a user pressing the film with an input means such as a finger, a pen or other similar object but not being limited thereto, the upper and lower electrodes are electrically connected to each other. Coordinates of a position corresponding to the electrically connected upper and lower electrodes are transferred to the analog-to-digital converting unit 200 as the analog signal supplied from the plurality of sensors via the plurality of sensors. A power supply unit (not shown) supplies power to the plurality of sensors. An offset noise and a random noise, as described above, overlap the sensor signal such that the analog signal supplied from the plurality of sensors includes the sensor signal, the offset noise, and the random noise overlapping each other.

The analog signal supplied from the plurality of sensors is converted to a raw data signal, which is a digital signal, by the analog-to-digital converting unit 200. The analog signal supplied from the plurality of sensors is also amplified by an amplifier (not shown). Since noises are amplified together with the amplified analog signal, SNR is lowered. The amplified signal is digitally converted and then transferred to the digital signal processing unit 300.

The offset signal is removed from the raw data transferred to the digital signal processing unit 300 and the random noise is further lowered, as described above. Hence, SNR is increased. More specifically, the raw data supplied to the digital signal processing unit 300 is aligned on a frame basis and an average of the raw data of the aligned frame is subtracted from the raw data to eliminate the offset noise, as described in further detail above. A random noise component of the raw data from which the offset noise has been removed is also removed, as described above, and the sensor signal is then identified by the digital signal processing unit 300.

Another exemplary embodiment of the present invention provides a liquid crystal display (“LCD”) device (not shown). The LCD device includes an LCD, to which the touch screen 100 is attached. A user inputs information by pressing the touch screen 100, as described above, and the digital signal processing unit 300 processes raw data as described above and outputs an identified sensor signal to the LCD.

In summary, the SNR of the sensor signal is increased as shown in FIGS. 4A and 4B to facilitate identification of the sensor signal despite the reduced overall level of the raw data. Thus, the plurality of sensors of the touch screen device work more precisely. Moreover, the amplifier which amplifies the analog signal supplied by the sensor may therefore have a smaller gain, and a cost of the sensor device is thereby reduced.

In an exemplary embodiment, SNR of a sensor signal is improved by extracting an offset noise from digitally-converted raw data and eliminating the extracted offset noise. Thus, a sensor signal may be identified even if a level of the signal supplied from a sensor of a touch screen is small.

The present invention should not be construed as being limited to the exemplary embodiments set forth herein. Rather, these exemplary embodiments are provided so that this disclosure will be thorough and complete and will fully convey the concept of the present invention to those skilled in the art.

It will be apparent to those skilled in the art that various modifications and/or variations can be made in the present invention without departing from the spirit or scope of the present invention as defined in the following claims.

What is claimed is:

1. A method of eliminating noise of a touch screen, the method comprising:
generating digital raw data by converting an analog signal inputted from a plurality of sensors of the touch screen;
aligning the digital raw data on a frame basis;
eliminating an offset noise from the digital raw data aligned on a frame basis; and
identifying a sensor signal within the digital raw data by comparing a variation of the digital raw data in a previous frame to a variation of the digital raw data in a current frame.

2. The method of claim 1, wherein the digital raw data comprises the sensor signal, the offset noise and a random noise.

3. The method of claim 1, wherein the aligning the digital raw data on a frame basis comprises sampling the digital raw data to extract desired data from the digital raw data aligned on a frame basis.

4. The method of claim 1, wherein the eliminating the offset noise comprises subtracting the offset noise corresponding to an average of the digital raw data received from the plurality of sensors over time.

5. The method of claim 2, further comprising eliminating the random noise from the digital raw data.

6. The method of claim 5, wherein the eliminating the random noise from the digital raw data comprises subtracting a random noise component of the previous frame from the digital raw data in the current frame.

7. A touch screen device comprising:
a touch screen having a plurality of sensors;
an analog-to-digital converting unit which generates digital raw data by converting an analog signal measured by the plurality of sensors; and
a digital signal processing unit which aligns the digital raw data on a frame basis, eliminates an offset noise from the digital raw data aligned on a frame basis, and identifies a sensor signal within the digital raw data by comparing a variation of the digital raw data in a previous frame to a variation of the digital raw data in a current frame.

8. The touch screen device of claim 7, wherein the digital signal processing unit further eliminates a random noise from the digital raw data by subtracting a random noise component of the previous frame from the digital raw data in the current frame.

9. A liquid crystal display device, comprising:
a liquid crystal display;
a touch screen having a plurality of sensors;
an analog-to-digital converting unit which generates digital raw data by converting an analog signal measured by the plurality of sensors into digital data; and
a digital signal processing unit which aligns the digital raw data on a frame basis, eliminates an offset noise from the digital raw data aligned on a frame basis, identifies a sensor signal within the digital raw by comparing a variation of the digital raw data in a previous frame to a variation of the digital raw data in a current frame, and outputs the identified sensor signal to the liquid crystal display.

10. The liquid crystal display device of claim 9, wherein the digital signal processing unit further eliminates a random noise from the digital raw data by subtracting a random noise component of the previous frame from the digital raw data in the current frame.
